(19) United States
(12) Patent Application Publication
(10) Pub. No.: US 2018/0169577 A1
(43) Pub. Date: Jun. 21, 2018

(54) Multi-level Gas Scrubber with Multiple Flooded Scrubber Heads

(71) Applicant: Pacific Green Technologies Inc., San Jose, CA (US)

(72) Inventor: Kenneth James MCCLELLAND, West Vancouver (CA)

(21) Appl. No.: 15/579,061

(22) PCT Filed: Nov. 2, 2015
(86) PCT No.: PCT/CA2015/000563

§ 371 Date: Dec. 1, 2017

Related U.S. Application Data
(60) Provisional application No. 62/169,856, filed on Jun. 2, 2015.

(51) Int. Cl. B01D 53/78; B01D 47/02; B01D 47/06; B01D 53/75; B01D 53/40; B01D 53/18; B01D 53/14

(52) U.S. Cl. CPC B01D 53/78; B01D 47/021; B01D 47/06; B01D 53/75; B01D 2258/0283; B01D 53/18; B01D 53/1406; B01D 53/1456; B01D 53/40

(57) ABSTRACT

The present invention relates to a wet scrubbing head design whose horizontal orientation and flooded operating characteristics allow complete wet scrubbing at multiple interaction zones each with different neutralizing reagents. The capacity for multiple scrubbing zones improves overall pollutant removal efficiency by adding polishing interaction zones for particulate and acid gas removal systems or by broadening the range of pollutants being removed by operating with a different neutralizing solution or a combination of these operating conditions. The flooded head design approach allows a single scrubber to accomplish high levels of removal efficiency for multiple pollutants which reduces cost, and footprint interaction complexities of the multiple devices it replaces. Flooded head scrubbers have application in combustion flue gas pollutant removal and in chemical and industrial applications that generate dust, odors and acid gases.

### FIELD OF INVENTION

The invention relates to the removal of air pollution emissions and particularly relates to an apparatus for scrubbing multiple contaminants from gases.

### BACKGROUND OF INVENTION

The air pollution emissions resulting from the combustion of coal, municipal solid waste and biomass, and air emissions from chemical and industrial processes have been increasingly restricted by governmental environmental agencies as a result of greater public demand for environmental protection coupled with advancements in pollution abatement technologies which allow more restrictive standards to be implemented. The restrictions vary by nation, region and proximity of the air pollution source to population centers. The regulations target a wide range of combustion by-products including particulate matter; acid gases such as sulphur dioxide, hydrogen chloride and hydrogen fluoride and metals such as mercury and metal groups known for their detrimental effects on human health. Many of the pollution abatement systems in use today by utilities and industrial processes have a history of development dating from the establishment of the first environmental regulations. These devices employ known chemical and mechanical processes to remove the regulated pollution components from gas streams. The stringent emission limits in force today and those more stringent limits pending implementation require alternative approaches. These alternative approaches include adding refinements to existing technologies to enhance their pollutant removal efficiency.

The emissions resulting from the combustion of diesel fuels in marine and power generation applications are also sources of regulated emissions. General cargo and container ships that carry the goods of international trade are burning bunker grade fuels that contain in the range of 2.5% to 2.7% sulphur. In addition, these marine diesel engines produce large amounts of ash, soot and unburned fuel that are emitted to the atmosphere on the world's oceans. The sulphur and particulate emissions are greater than permitted by the environmental regulations for land based operations. Regulations for these emissions in territorial waters as well as dockside are being implemented by regional and national environmental agencies and in international waters by the International Marine Organization. The options available to meet the demands of these regulation include adding scrubbing technologies or changing the fuel supply for ships to low sulphur fuels.

Emission technologies for the combustion processes noted above generally can be divided into wet and dry systems. Dry systems utilize different technologies to address the removal of acid gases and particulate. Dry flue gas desulphurization is commonly accomplished by devices such as a spray dryer tower. Common among the dry particulate systems are bag filters and electrostatic precipitators.

Wet systems used in conjunction with combustion flue gases commonly use aqueous based slurry containing an alkaline material such as limestone, lime, hydrated lime or enhanced lime as a neutralizing agent. Wet scrubbing systems employ several methods to create an interaction between the aqueous slurry and the contaminated flue gas. A simple approach uses sprayers in a spray tower or similar device to distribute the slurry into the flue gas to remove sulphur dioxide, hydrogen chloride and hydrogen fluoride through reaction with the slurry to form calcium based compounds. The interaction between the flue gas and the sprayed slurry is general in nature and is not as efficient or effective as forced wet scrubbing systems.

Forced wet scrubbing systems employ design approaches which force the flue gas into alkaline reagents contained in an aqueous slurry. The design of these systems creates a turbulent reaction zone that increases reaction time, and ensures complete interaction between the flue gas and alkaline slurry which improves acid gas removal efficiency. In addition, the turbulent zone creates an environment for the transfer of particulate matter from the flue gas to the scrubbing solution. These turbulent zones are generated by scrubbing heads containing ports submerged in a body of scrubbing fluid. The flue gas passes through the ports at high velocity which creates a turbulent zone in the scrubbing solution that transfers the particulate and provides a reaction zone for chemical interactions.

Thus, this form of wet system has the capacity to remove multiple pollutants in a single pass. It is however, limited to operating with a single interaction in the scrubbing fluid reservoir, typically located at the base of the scrubber. Its approach does not allow stacking the scrubbing heads so as to attain multiple scrubbing zones as the gas rises through the scrubber.

The more restrictive emission limits being imposed on industry to control air pollutants from combustion, industrial and chemical processes require enhanced approaches in order to provide high efficiency and cost-effective abatement systems.

### SUMMARY OF INVENTION

There is provided a vertically-oriented scrubber apparatus for removing a plurality of distinct contaminants from a contaminated gas stream, having a scrubber vessel having a ceiling, a floor, a cylindrical wall connecting the ceiling to the floor, a plurality of vertically-spaced heads, a velum above each head, a gas inlet, an induced draft fan, and a gas outlet; a submerged lower head positioned horizontally across the lower end of the scrubber vessel, wherein the submerged lower head includes a horizontal plate having a plurality of narrow slots extending throughout; a first scrubbing fluid reservoir disposed within the bottom end of the scrubber vessel below the submerged lower head, and a first reaction zone volume to a desired level above the submerged scrubbing head, the first scrubbing fluid selected to remove a first group of contaminants from the contaminated gas stream; a first scrubbing fluid inlet extending into a first velum above the submerged head, first spraying means in fluid connection with the first scrubbing fluid inlet for spraying the first scrubbing fluid into the first scrubbing fluid reaction zone volume, and a first scrubbing fluid outlet in the floor; a first flooded head extending horizontally across the entire cross-section of the scrubber vessel at a position above the first scrubbing fluid inlet, wherein the first flooded head comprises a plate having a plurality of narrow slots extending throughout; a second scrubbing fluid reaction zone volume disposed to a desired level above the first flooded head, the second scrubbing fluid selected to remove a second group of contaminants from the contaminated gas stream; and a second scrubbing fluid inlet extending into a second velum above the first flooded head, second spraying means in fluid connection with the second scrubbing fluid inlet for spraying the second scrubbing fluid into the second scrubbing fluid reaction zone volume, and a second scrubbing fluid outlet above the first flooded head passing through the scrubber vessel wall.

There is further provided a vertically-oriented scrubber apparatus for removing a plurality of distinct contaminants from a contaminated gas stream, having a scrubber vessel having a ceiling, a floor, a cylindrical wall connecting the ceiling to the floor, a plurality of vertically-spaced heads, a velum above each head, a gas inlet, an induced draft fan, and a gas outlet; a first scrubbing fluid reservoir disposed within the bottom end of the scrubber vessel to a desired level, the first scrubbing fluid selected to remove a first group of contaminants from the contaminated gas stream; a first flooded head extending horizontally across the scrubber vessel at a position above the gas inlet, defining a first velum between the first scrubbing fluid reservoir and the first flooded head, wherein the first flooded head comprises a plate having a plurality of narrow slots extending throughout; a first scrubbing fluid reaction zone volume disposed to a desired level above the first flooded head, the reaction zone volume in fluid connection with the reservoir via one or more overflow tubes, each extending from the first scrubbing fluid reservoir through the first flooded head to a desired level above the first flooded head; a first scrubbing fluid inlet extending through the wall into a second velum above the first flooded head, first spraying means in fluid connection with the first scrubbing fluid inlet for spraying the first scrubbing fluid into the second scrubbing fluid reaction zone volume, and a first scrubbing fluid outlet in the floor; a second flooded head extending horizontally across the entire cross-section of the scrubber vessel at a position above the first flooded head, defining a second velum between the first scrubbing fluid reaction zone volume and the second flooded head, wherein the second flooded head comprises a plate having a plurality of narrow slots extending throughout; a second scrubbing fluid reaction zone volume disposed above the second flooded head to a desired level, the second scrubbing fluid selected to remove a second group of contaminants from the contaminated gas stream; and a second scrubbing fluid inlet extending into a third velum above the second flooded head, second spraying means in fluid connection with the second scrubbing fluid inlet for spraying the second scrubbing fluid into the second scrubbing fluid reaction zone volume, and a second scrubbing fluid outlet above the second flooded head passing through the wall of the scrubber vessel.

The scrubber apparatus may have one or more additional flooded heads extending horizontally across the entire cross-section of the scrubber vessel and stacked vertically above the other heads, each defining an additional velum in relation to the head below; one or more additional scrubbing fluid reaction zone volumes, each disposed above a corresponding flooded head to a desired level, each additional scrubbing fluid selected to remove a desired additional group of contaminants from the contaminated gas stream; and one or more additional scrubbing fluid inlets extending through the wall into the corresponding additional velum above the corresponding additional flooded head, additional corresponding spraying means in fluid connection with the additional scrubbing fluid inlet for spraying the additional scrubbing fluid into the corresponding additional scrubbing fluid reaction zone volume, and one or more corresponding additional scrubbing fluid outlets above the corresponding flooded head passing through the wall of the scrubber vessel.

The gas inlet may be located at the top end of the vessel and a gas inlet duct conducts the gas to a position below the lowermost head; or at the side of the vessel and a gas inlet duct conducts the gas to a position below the lowermost head; or below the lowermost head of the vessel.

The apparatus may further comprise a mist eliminator consisting of an absorbent mesh extending across the scrubber vessel. Each of the spraying means may be one or more spray nozzles. The size of the slots in the flooded heads may be selected to prevent passage therethrough of scrubbing fluid in the presence of pressurized gas below the head.

There is further provided the use of such a scrubber apparatus remove multiple contaminants from a contaminated gas stream according to a method comprising the steps of introducing a first scrubbing fluid into the apparatus to a desired fluid level above the lowermost scrubber head; introducing a second scrubbing fluid into the apparatus to a desired level above the next highest scrubber head; cooling a contaminated process gas using a prior art gas conditioner; introducing the cooled contaminated gas under pressure from an induced draft fan into the apparatus at a position below the lowermost scrubber head; allowing the gas to pass upwardly through the lowermost scrubber head to transfer a first group of contaminants from the contaminated gas into the first scrubbing fluid in a first scrubbing fluid reaction zone volume above the lowermost scrubber head; allowing the gas to continue passing upwardly through the next highest scrubber head to transfer a second group of contaminants from the contaminated gas into the second scrubbing fluid in a second scrubbing fluid reaction zone volume above the next highest scrubber head; spraying the exiting gas to remove additional contaminants and slow the gas flow velocity; allowing the exiting gas to exit the scrubbing apparatus; separately removing first and second scrubbing fluids from the scrubber vessel to maintain a desired level of each scrubbing fluid; and cleaning drained scrubbing fluids for reuse in the scrubbing apparatus.

The invention provides a scrubber apparatus for removing multiple contaminants from a contaminated gas stream, comprising a scrubber vessel having a series of vertically-stacked scrubber heads, each scrubber head flooded with a different scrubbing fluid, each scrubbing fluid selected to remove a desired group of contaminants from the contaminated gas stream, wherein the contaminated gas flows under pressure from below the lowermost scrubber head upwardly through the series of flooded scrubber heads.

The apparatus may be used to remove from a contaminated gas stream multiple contaminants selected from the group of contaminants comprising particulate matter, metals, hydrogen chloride, hydrogen fluoride, nitrous oxide, nitric oxide, carbon dioxide, and sulfur dioxide.

The present invention employs a proprietary flooded horizontal scrubbing head that occupies the entire scrubber cross section. The polluted gas passes from below to above the head through an array of ports cut into the head. Scrubbing fluid is supported above the head by the gas as the gas passes through ports at high velocity to create a turbulent reaction zone within the supported scrubbing fluid. The level of scrubbing fluid is controlled by overflow pipes or troughs and fluid is constantly added by distribution nozzles located above the turbulent zone. Further flooded horizontal heads can be added above the initial head at vertical intervals in the scrubber's cross-section. Using the flooded head approach, the present invention allows complete wet scrubbing at multiple levels, each level capable of operating with different neutralizing reagents. The capacity for multiple scrubbing zones provides the opportunity to improve overall removal efficiencies by adding polishing reaction zones for particulate and acid gas removal or by broadening the range of pollutants being removed by operating with a different neutralizing solution, or a combination of these operating conditions.

The present invention takes a novel approach to the creation of a turbulent scrubbing reaction zone at each of multiple levels with the capacity to use different neutralizing reagents at each level. Whereas traditional approaches use pressure differential across a scrubbing head to force gas through an array of ports submerged in a body of fluid, the present invention uses pressure differential to support the scrubbing fluid on top of a horizontal scrubbing head. The horizontal scrubbing head contains an array of ports through which the gas passes vertically upward into the flooded zone. The pressure differential and port design accelerates the gas sufficiently to create the desired highly turbulent reaction in the flooded zone above the head. The horizontal orientation of the scrubbing head allows multiple heads to be stacked within the same scrubber body. The flooded scrubber heads occupy the entire cross section of the scrubber body which devotes 100% of the scrubber's cross sectional area to scrubbing and the transit of gas. The horizontal orientation allows the scrubbing head to be any shape required by the space available for the scrubbing equipment. Because it has the capacity to remove multiple pollutants in a single pass the system has a smaller footprint than the accumulation of equipment that it replaces and as a single unit it is more cost-effective than multiple single purpose units. The flooded head can be incorporated into new scrubber designs or retrofitted into existing wet scrubbers using a submerged head design approach at its lowest level.

The flooded scrubbing head system is based upon a vertical orientation of the scrubber body and the horizontal orientation of the flooded scrubbing heads. The gas enters a plenum area above the scrubbing fluid reservoir in the base of the scrubber body and below the first flooded head. The gas is moved to the plenum by an induced draft fan capable of providing the volume required for the flue gas emission and pressure differential required to support the multiple reaction zones above the scrubbing head levels in the design. The pressure in the plenum is sufficient to force the gas through ports in the head and into a turbulent reaction zone above the head. The size, shape and plurality of the ports in the head are such that the gas is sufficiently accelerated to create the desired depth and vigor of turbulence above the head.

The fluid on each head is continuously circulated. The scrubbing fluid is pumped from a fluid reservoir to a network of fluid distribution nozzles that deliver scrubbing fluid to the area above each head. Return to the reservoir is provided by fluid level controls such as overflow troughs or standpipes that pipe the fluid back to the reservoir. The condition of the returning fluid is monitored for control factors such as pH and the reservoir is conditioned with additional neutralizing reagents to return the fluid to its optimum reaction condition before redistribution above the head. In addition, the fluid may be processed by solids removal devices such as hydrocyclones to remove particulate matter collected by the scrubbing fluid.

As the gas continues to rise in the flooded head scrubber it encounters additional flooded scrubbing heads with the same configuration of ports, fluid distribution and overflows to fluid reservoirs. In cases where different scrubbing fluids are employed, the overflows direct the alternative scrubbing

Upon exiting the turbulent zone of the final head the gas rises through demisters or similar devices to remove free water from the gas. The gas is available to be ducted to the stack or further processes if required.

The flooded head system can also be used in conjunction with submerged scrubbing heads at the base level of the scrubber. After exiting the turbulent zone above the submerged scrubbing head the gas rises under pressure to a flooded head(s) that operate in the full cross section of the scrubber in the same manner as described above.

### BRIEF DESCRIPTION OF DRAWINGS

A detailed description of the preferred embodiment is provided below by way of example only and with reference to the following drawings in which:

FIG. 1A is a top view of a schematic drawing of one embodiment of the flooded scrubber head of the present invention;

FIG. 1B is a lateral cross-sectional view through 1B-1B of the flooded scrubber head depicted in FIG. 1A;

FIG. 1C is a blow-up schematic view of one corner of the embodiment of a flooded scrubber head shown in FIG. 1A;

FIG. 2 is a cross-sectional view of a multiple level scrubber having the flooded scrubber head of the present invention at each scrubbing level; and

FIG. 3 is a schematic of an embodiment of a system where initial scrubbing is performed by a submerged scrubbing head and the flooded scrubber head of the present invention is used for scrubbing on subsequent levels above the initial head.

### DETAILED DESCRIPTION OF THE INVENTION

The present invention provides a means of creating multiple wet scrubbing interaction levels 2, 4 within a single scrubber vessel 11, each level of which is capable of scrubbing 100% of the gas flow with a different scrubbing fluid. The present invention uses a scrubber head design whose horizontal orientation and flooded operating characteristics allow the stacking of multiple heads within a single wet scrubber body. The ability to incorporate additional scrubbing interaction zones in a single system provides the opportunity to increase overall removal efficiency for pollutants such as particulate matter, acid gases or metals by adding polishing steps or to remove additional regulated pollutants by utilizing other neutralizing reagents. By incorporating the flooded scrubber heads of the present invention in wet scrubber designs the resulting system will have lower capital costs, a smaller footprint and higher efficiency removal of multiple pollutants.

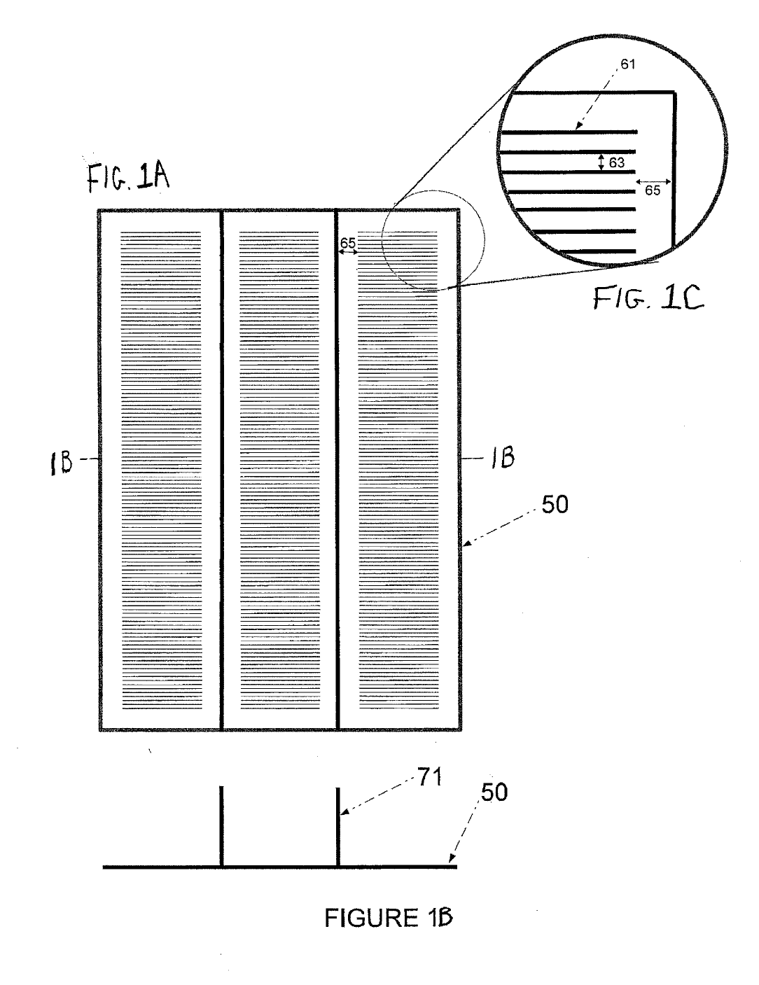

Referring to FIGS. 1A to 1C, the scrubbing head 50 is shown as a generic form to demonstrate the elements of the head. The head 50 operates in a horizontal orientation. The head may be manufactured from any sheet or plate material with sufficient strength, stiffness, and thermal and chemical resistance properties. Typical materials are metal plate with the preferred materials being stainless steel. The horizontal cross-sectional shape of the head conforms to the shape of the scrubber body so as to allow a sealed fit between the periphery of the scrubber head and the inner circumference of the scrubber vessel. The head contains a plurality of ports 61 that may be in any shape, number and orientation to the head. The preferred port shape is a slot with length in the range of 125 to 200 mm with a preferred width of 2 mm. The spacing 63 of the ports is typically in the range of 20 to 25 mm. The margins 65 between the ports and the edge of the head are uniform with a preferred distance of 40 mm. The head may contain accelerator plates 71 oriented at right angles to the head. The accelerator plates equally divide the space between the rows of ports 61. The margin 65 between the accelerator plates and the ports 61 is maintained at a preferred distance of 40 mm. The accelerator plates are typically 150 mm in height and contain scuppers at the head deck level to allow the lateral transfer of scrubbing fluid. The accelerator plate is of the same material as the scrubber head. Other parameters for the ports, margins, and accelerator plates are permitted within the scope of the invention.

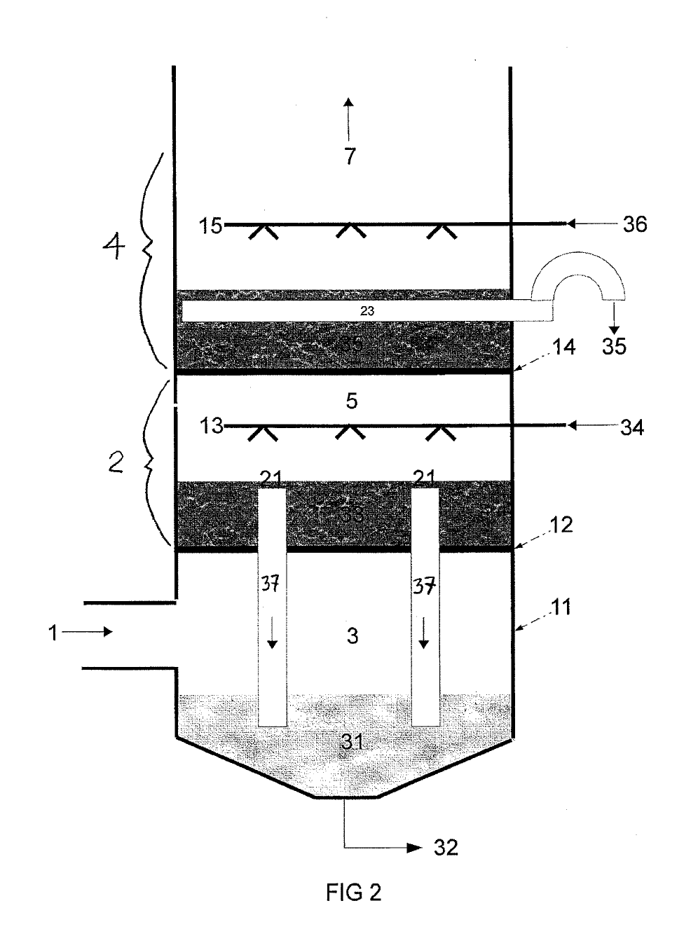

Referring to FIG. 2, there is depicted an example of a scrubber system incorporating the flooded scrubber heads of the present invention which is comprised of a scrubbing vessel (11) containing two flooded heads 12, 14.

The process of gas contamination removal using the system of FIG. 2 begins with introduction of the contaminated gas 1 from a combustion or industrial process that generates particulate matter, acid gases and metals that require removal. The gas enters a lowermost plenum 3 bounded by a reservoir of a first scrubbing fluid 31 (or a solid membrane) below and a flooded head 12 above. The gas enters under positive pressure created by an induced draft fan (not shown). The gas pressure is sufficient to support a desired depth of a first scrubbing fluid on the heads 12, 14 and to overcome the pressure drop incurred by the gas as it passes through the ports in the heads. Preferred pressure at the lowermost plenum 3 is 450 mm of water. The gas rises through the ports in the lowermost head 12 at a velocity in the range of 20 to 25 meters per second. The gas enters a turbulent first scrubbing fluid reaction zone volume 33 where the gas and first scrubbing fluid are aggressively mixed. The first scrubbing fluid is selected for it reactivity with a first group of contaminants targeted for removal. The first scrubbing fluid level on the lowermost head 12 is controlled by overflow tubes that pass through the head to the first scrubbing fluid reservoir 31 that is typically located in the base of the scrubber vessel 11. The overflow first scrubbing fluid 37 is replaced by conditioned first scrubbing fluid 34 from a first scrubbing fluid inlet distribution header 13 in order to maintain fluid level and reactivity with the contaminants being removed. In addition to chemical reactivity, the aggressive turbulence created in the wet scrubber will efficiently remove particulate matter from the gas and transfer it to the scrubbing fluid. After exiting the turbulent first scrubbing fluid reaction zone volume the gas rises under the remaining pressure to repeat the process, passing through a second flooded head 14 into a turbulent second scrubbing fluid reaction zone volume 35. For illustrative purposes the depth of the second scrubbing fluid reaction zone volume 35 is controlled by a second scrubbing fluid outlet, which may be a plurality of overflow troughs 23 that transfer the second scrubbing fluid from the scrubber vessel and route it to a second scrubbing fluid reservoir not shown. Using this approach, the second scrubbing fluid on head 14 can be a different scrubbing fluid than that on head 12, thus allowing polishing or alternative contaminants to be removed. Second scrubbing fluid on head 14 is constantly replaced with conditioned scrubbing fluid 36. The decontaminated gas 7 exiting the second scrubbing fluid reaction zone volume 35 can be ducted to the stack or further processes. Using this same approach, additional flooded scrubbing heads may be serially added vertically within the scrubber body for further polishing or removal of other air pollutants as required by the process.

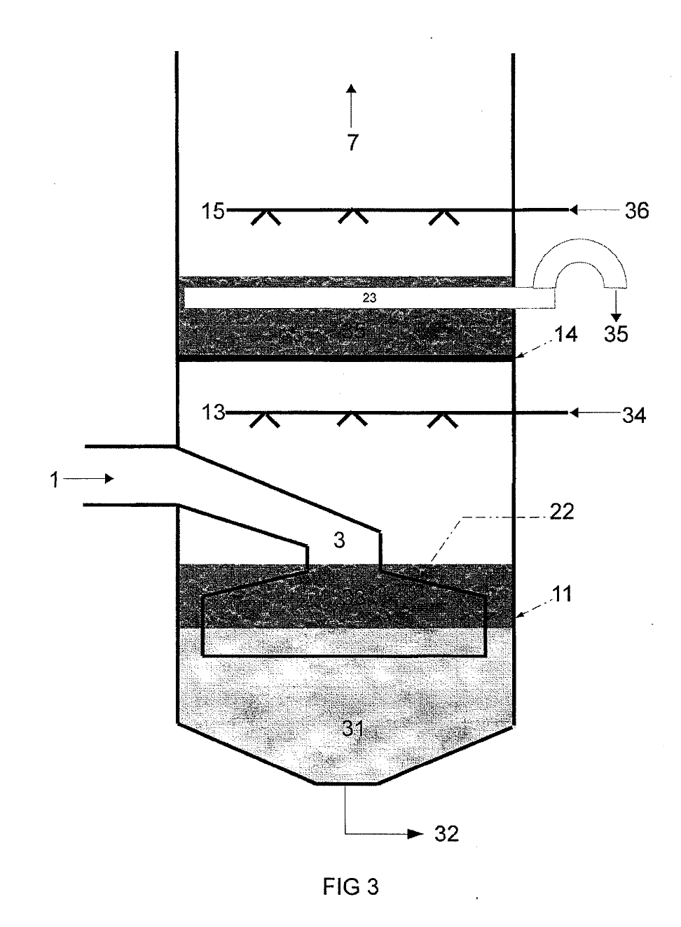

Referring to FIG. 3, there is shown an example of a system comprising a scrubbing vessel 11 containing a submerged lowermost head 22 beneath a flooded head 14 functioning as a second scrubbing head.

The process in FIG. 3 begins with the contaminated gas 1 from a combustion or industrial process that generates particulate matter, acid gases and metals that require removal. The gas is ducted to the submerged scrubber head 22. The gas enters under positive pressure created by an induced draft fan (not shown). The gas pressure is sufficient to overcome the pressure created by the depth of a first scrubbing fluid on the lowermost head 22 and support the depth of a second scrubbing fluid to be supported on the second flooded head 14. Additional gas pressure is incorporated into the design to overcome the pressure drop incurred by the gas as it passes through the ports in the heads and losses incurred in the ducting of the gas. Preferred pressure at the lowermost plenum 3 is 450 mm of water. The gas rises through the ports in the submerged head 22 at a velocity determined by the design of the head. The gas enters a turbulent first scrubbing fluid reaction zone volume 33 where the gas and first scrubbing fluid are aggressively mixed in a turbulent first scrubbing fluid reaction zone volume. The first scrubbing fluid is selected for its reactivity with a first group of contaminants targeted for removal. The first scrubbing fluid level on the submerged head 22 is controlled by sensors such as differential pressure sensors which activate control valves to regulate the flow of fluid exiting for recirculation via a first scrubbing fluid outlet 32 in the floor of the vessel. Conditioned first scrubbing fluid 34 is added through a first scrubbing fluid inlet distribution header 13 in order to maintain reactivity with the contaminants being removed. In addition to chemical reactivity, the aggressive turbulence created in the wet scrubber will efficiently remove particulate matter from the gas and transfer it to the scrubbing fluid. After exiting the turbulent first scrubbing fluid reaction zone volume 33 the gas rises under the remaining pressure to repeat the process, passing through flooded head 14 into a turbulent second scrubbing fluid reaction zone volume 35. For illustrative purposes the depth of the second scrubbing fluid reaction zone volume 35 is controlled by a second scrubbing fluid outlet, which may be a plurality of overflow troughs 23 that transfer the second scrubbing fluid from the scrubber vessel and route it to a second scrubbing fluid reservoir (not shown). Using this approach, the upper flooded head 14 can operate with a different scrubbing fluid than is used on the submerged head 22 thus allowing polishing or the addition of alternative reagents to remove other regulated contaminants. Second scrubbing fluid on the flooded head 14 is constantly replaced with conditioned second scrubbing fluid 36 carried by second scrubbing fluid inlet distribution header 15. The decontaminated gas 7 exiting the second scrubbing fluid reaction zone volume can be ducted to the stack or further processes. Using this same approach, additional flooded scrubbing heads may be serially added vertically within the scrubber vessel for further polishing or removal of other air pollutants as required by the process.

One or more flooded scrubbing heads as embodied in the present invention offer advantages over the current art represented by submerged scrubbing heads. Among the advantages is the ability to supply wet scrubbing of 100% of the gas at multiple levels of interaction zones with different neutralizing reagents within a single scrubbing body. This attribute allows a single scrubbing device to remove a broader range of pollutants at higher removal efficiencies. Scrubbers utilizing the flooded head design will have a smaller and highly flexible footprint, lower capital cost, scalability and capacity to remove multiple pollutants in a single device. The flooded head has application in combustion processes including coal, biomass and municipal solid waste where the primary pollutants targeted for removal are particulate matter, acid gases including sulphur dioxide, hydrogen chloride and hydrogen fluoride, metals including mercury. In addition, scrubbers used in chemical and industrial processes requiring the removal of dust, odors and acid gases are candidates for flooded head designs in both new and retrofit installations.

From the foregoing, it will be seen that this invention is one well adapted to attain all of the ends and objectives herein set forth, together with other advantages which are obvious and which are inherent to the system. It will be understood that certain features and sub-combinations are of utility and may be employed with reference to other features and sub-combinations. This is contemplated by and is within the scope of the claims. Many possible embodiments may be made of the invention without departing from the scope of the claims. It is to be understood that all matter herein set forth and shown in the accompanying drawings is to be interpreted as illustrative and not in a limiting sense. It will be appreciated by those skilled in the art that other variations of the preferred embodiment may also be practiced without departing from the scope of the invention.

What is claimed is:

1. A vertically-oriented scrubber apparatus for removing a plurality of distinct contaminants from a contaminated gas stream, comprising:
a) a scrubber vessel having a ceiling, a floor, a cylindrical wall connecting the ceiling to the floor, a plurality of vertically-spaced heads, a velum above each head, a gas inlet, an induced draft fan, and a gas outlet;
b) a submerged lower head positioned horizontally across the lower end of the scrubber vessel, wherein the submerged lower head includes a horizontal plate having a plurality of narrow slots extending throughout;
c) a first scrubbing fluid reservoir disposed within the bottom end of the scrubber vessel below the submerged lower head, and a first reaction zone volume to a desired level above the submerged scrubbing head, the first scrubbing fluid selected to remove a first group of contaminants from the contaminated gas stream;
d) a first scrubbing fluid inlet extending into a first velum above the submerged head, first spraying means in fluid connection with the first scrubbing fluid inlet for spraying the first scrubbing fluid into the first scrubbing fluid reaction zone volume, and a first scrubbing fluid outlet in the floor;
e) a first flooded head extending horizontally across the entire cross-section of the scrubber vessel at a position above the first scrubbing fluid inlet, wherein the first flooded head comprises a plate having a plurality of narrow slots extending throughout;
f) a second scrubbing fluid reaction zone volume disposed to a desired level above the first flooded head, the second scrubbing fluid selected to remove a second group of contaminants from the contaminated gas stream; and
g) a second scrubbing fluid inlet extending into a second velum above the first flooded head, second spraying means in fluid connection with the second scrubbing fluid inlet for spraying the second scrubbing fluid into the second scrubbing fluid reaction zone volume, and a second scrubbing fluid outlet above the first flooded head passing through the scrubber vessel wall.

2. A vertically-oriented scrubber apparatus for removing a plurality of distinct contaminants from a contaminated gas stream, comprising:
a) a scrubber vessel having a ceiling, a floor, a cylindrical wall connecting the ceiling to the floor, a plurality of vertically-spaced heads, a velum above each head, a gas inlet, an induced draft fan, and a gas outlet;
b) a first scrubbing fluid reservoir disposed within the bottom end of the scrubber vessel to a desired level, the first scrubbing fluid selected to remove a first group of contaminants from the contaminated gas stream;
c) a first flooded head extending horizontally across the scrubber vessel at a position above the gas inlet, defining a first velum between the first scrubbing fluid reservoir and the first flooded head, wherein the first flooded head comprises a plate having a plurality of narrow slots extending throughout;
d) a first scrubbing fluid reaction zone volume disposed to a desired level above the first flooded head, the reaction zone volume in fluid connection with the reservoir via one or more overflow tubes, each extending from the first scrubbing fluid reservoir through the first flooded head to a desired level above the first flooded head;
f) a first scrubbing fluid inlet extending through the wall into a second velum above the first flooded head, first spraying means in fluid connection with the first scrubbing fluid inlet for spraying the first scrubbing fluid into the second scrubbing fluid reaction zone volume, and a first scrubbing fluid outlet in the floor;
g) a second flooded head extending horizontally across the entire cross-section of the scrubber vessel at a position above the first flooded head, defining a second velum between the first scrubbing fluid reaction zone volume and the second flooded head, wherein the second flooded head comprises a plate having a plurality of narrow slots extending throughout;
h) a second scrubbing fluid reaction zone volume disposed above the second flooded head to a desired level, the second scrubbing fluid selected to remove a second group of contaminants from the contaminated gas stream; and
i) a second scrubbing fluid inlet extending into a third velum above the second flooded head, second spraying means in fluid connection with the second scrubbing fluid inlet for spraying the second scrubbing fluid into the second scrubbing fluid reaction zone volume, and a second scrubbing fluid outlet above the second flooded head passing through the wall of the scrubber vessel.

3. The scrubber apparatus of claim 1, further comprising:
a) one or more additional flooded heads extending horizontally across the entire cross-section of the scrubber vessel and serially stacked vertically above the other heads, each defining an additional velum in relation to the head below;
b) one or more additional scrubbing fluid reaction zone volumes, each disposed above a corresponding flooded head to a desired level, each additional scrubbing fluid selected to remove a desired additional group of contaminants from the contaminated gas stream; and
c) one or more additional scrubbing fluid inlets extending through the wall into the corresponding additional velum above the corresponding additional flooded head, additional corresponding spraying means in fluid connection with the additional scrubbing fluid inlet for spraying the additional scrubbing fluid into the corresponding additional scrubbing fluid reaction zone volume, and one or more corresponding additional scrubbing fluid outlets above the corresponding flooded head passing through the wall of the scrubber vessel.

4. The scrubber apparatus of claim 2, further comprising:
a) one or more additional flooded heads extending horizontally across the entire cross-section of the scrubber vessel and serially stacked vertically above the other heads, each defining an additional velum in relation to the head below;
b) one or more additional scrubbing fluid reaction zone volumes, each disposed above a corresponding flooded head to a desired level, each additional scrubbing fluid selected to remove a desired additional group of contaminants from the contaminated gas, stream; and
c) one or more additional scrubbing fluid inlets extending through the wall into the corresponding additional velum above the corresponding additional flooded head, additional corresponding spraying means in fluid connection with the additional scrubbing fluid inlet for spraying the additional scrubbing fluid into the corresponding additional scrubbing fluid reaction zone volume, and one or more corresponding additional scrubbing fluid outlets above the corresponding flooded head passing through the wall of the scrubber vessel.

5. The scrubber apparatus of claim 2, wherein the gas inlet is located at the top end of the vessel and a gas inlet duct conducts the gas to a position below the lowermost head.

6. The scrubber apparatus of claim 2, wherein the gas inlet is located at the side of the vessel and a gas inlet duct conducts the gas to a position below the lowermost head.

7. The scrubber apparatus of claim 2, wherein the size of the slots in the flooded heads are selected to prevent passage therethrough of scrubbing fluid in the presence of pressurized gas below the flooded heads.

8. A method of removing multiple contaminants from a contaminated gas stream, the method comprising the steps of:
a) introducing a first scrubbing fluid into the apparatus of claim 1 to a desired fluid level above the submerged scrubber head;
b) introducing a second scrubbing fluid into the apparatus of claim 1 to a desired level above the flooded scrubber head;
c) cooling a contaminated process gas using a prior art gas conditioner;
d) introducing the cooled contaminated gas under pressure from an induced draft fan into the apparatus of claim 1 at a position below the submerged scrubber head;
e) allowing the gas to pass upwardly through the submerged scrubber head to transfer a first group of contaminants from the contaminated gas into the first scrubbing fluid in a first scrubbing fluid reaction zone volume above the submerged scrubber head;
f) allowing the gas to continue passing upwardly through the flooded head to transfer a second group of contaminants from the contaminated gas into the second scrubbing fluid in a second scrubbing fluid reaction zone volume above the flooded head;
g) spraying the exiting gas to remove additional contaminants and slow the gas flow velocity;
h) allowing the exiting gas to exit the scrubbing apparatus;
i) separately removing first and second scrubbing fluids from the scrubber vessel to maintain a desired level of each scrubbing fluid; and
j) cleaning drained scrubbing fluids for reuse in the scrubbing apparatus.

9. The use of the scrubber apparatus of claim 1 to remove multiple contaminants from a contaminated gas stream according to the method of claim 8.

10. The method of claim 9, further comprising the additional step (ff) after step (f) of:
ff) allowing the gas to continue passing upwardly through one or more serially vertically stacked additional flooded heads to transfer one or more additional groups of contaminants from the contaminated gas into one or more additional scrubbing fluids in each of one or more additional scrubbing fluid reaction zone volumes above each of the corresponding flooded heads.

11. A method of removing multiple contaminants from a contaminated gas stream, the method comprising the steps of:
a) introducing a first scrubbing fluid into the apparatus of claim 2 to a desired fluid level above the first flooded scrubber head;
b) introducing a second scrubbing fluid into the apparatus of claim 2 to a desired level above the second flooded scrubber head;
c) cooling a contaminated process gas using a prior art gas conditioner;
d) introducing the cooled contaminated gas under pressure from an induced draft fan into the apparatus of claim 2 at a position below the first flooded scrubber head;
e) allowing the gas to pass upwardly through the first flooded head to transfer a first group of contaminants from the contaminated gas into the first scrubbing fluid in a first scrubbing fluid reaction zone volume above the first flooded head;
f) allowing the gas to continue passing upwardly through the second flooded head to transfer a second group of contaminants from the contaminated gas into the second scrubbing fluid in a second scrubbing fluid reaction zone volume above the second flooded head;
g) spraying the exiting gas to remove additional contaminants and slow the gas flow velocity;
h) allowing the exiting gas to exit the scrubbing apparatus;
i) separately removing first and second scrubbing fluids from the scrubber vessel to maintain a desired level of each scrubbing fluid; and
j) cleaning drained scrubbing fluids for reuse in the scrubbing apparatus.

12. The use of the scrubber apparatus of claim 2 to remove multiple contaminants from a contaminated gas stream according to method of claim 11.

13. The method of claim 11, further comprising the additional step (ff) after step (f) of:
ff) allowing the gas to continue passing upwardly through one or more serially vertically stacked additional flooded heads to transfer one or more additional groups of contaminants from the contaminated gas into one or more additional scrubbing fluids in each of one or more additional scrubbing fluid reaction zone volumes above each of the corresponding flooded heads.

14. The use of the apparatus of claim 1 to remove from a contaminated gas stream multiple contaminants selected from the group of contaminants comprising particulate matter, metals, hydrogen chloride, hydrogen fluoride, nitrous oxide, nitric oxide, carbon dioxide, and sulfur dioxide.

15. The use of the apparatus of claim 2 to remove from a contaminated gas stream multiple contaminants selected from the group of contaminants comprising particulate matter, metals, hydrogen chloride, hydrogen fluoride, nitrous oxide, nitric oxide, carbon dioxide, and sulfur dioxide.

16. A scrubber apparatus for removing multiple contaminants from a contaminated gas stream, comprising a scrubber vessel having a series of vertically-stacked scrubber heads, each scrubber head flooded with a different scrubbing fluid to create a separate scrubbing fluid reaction zone volume above each scrubber head, each scrubbing fluid selected to remove a desired group of contaminants from the contaminated gas stream, wherein the contaminated gas flows under pressure from below the lowermost scrubber head upwardly through the series of flooded scrubber heads.

17. A method of removing multiple contaminants from a contaminated gas stream, the method comprising the steps of:
a) introducing a first scrubbing fluid into the apparatus of claim 16 to a desired fluid level above the first scrubber head;
b) introducing a second scrubbing fluid into the apparatus of claim 16 to a desired level above the second scrubber head;
c) cooling a contaminated process gas using a prior art gas conditioner;
d) introducing the cooled contaminated gas under pressure from an induced draft fan into the apparatus of claim 16 at a position below the first scrubber head;
e) allowing the gas to pass upwardly through the first head to transfer a first group of contaminants from the contaminated gas into the first scrubbing fluid in a first scrubbing fluid reaction zone volume above the first head;
f) allowing the gas to continue passing upwardly through the second head to transfer a second group of contaminants from the contaminated gas into the second scrubbing fluid in a second scrubbing fluid reaction zone volume above the second head;
g) spraying the exiting gas to remove additional contaminants and slow the gas flow velocity;
h) allowing the exiting gas to exit the scrubbing apparatus;
i) separately removing first and second scrubbing fluids from the scrubber vessel to maintain a desired level of each scrubbing fluid; and
j) cleaning drained scrubbing fluids for reuse in the scrubbing apparatus.

18. The use of the apparatus of claim 16 to remove from a contaminated gas stream multiple contaminants selected from the group of contaminants comprising particulate matter, metals, hydrogen chloride, hydrogen fluoride, nitrous oxide, nitric oxide, carbon dioxide, and sulfur dioxide.

19. A flooded scrubber head for a wet gas scrubbing vessel, the flooded head comprising:
a) a horizontal plate extending across the entire lateral cross-section of the scrubbing vessel, the head having one or more rows of ports for the upward passage therethrough of contaminated gases into a scrubbing fluid reaction zone volume above the head, wherein the entire perimeter of the head is adjacent to the inner circumference of the scrubbing vessel, and the size, shape and angle of the ports is selected to prevent the scrubbing fluid from passing downward through the ports in the presence of pressurized gas below the head.

20. The flooded wet scrubber head of claim 19, wherein the head further comprises one or more accelerator plates extending upwardly perpendicular to the head between the one or more rows of ports into the scrubbing fluid reaction zone volume.
